(19) United States
(12) Patent Application Publication
(10) Pub. No.: US 2025/0109900 A1
(43) Pub. Date: Apr. 3, 2025

(54) HEATING DEVICE FOR MELTING ICE IN AN ICE WELL

(71) Applicant: Daniel Almeroth, San Diego, CA (US)

(72) Inventor: Daniel Almeroth, San Diego, CA (US)

(21) Appl. No.: 18/376,305

(22) Filed: Oct. 3, 2023

(51) Int. Cl. F25C 5/08

(52) U.S. Cl. CPC F25C 5/08

(57) ABSTRACT

A heating device for melting ice in an ice well includes a body constructed of a fluid impermeable material which is flexible such that the body is configured to conform to an exterior of a pile of the ice. The body defines a plurality of holes which extend through the body to facilitate draining water through the body. A resistive heating wire is embedded in the body.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to heating devices and more particularly pertains to a new heating device for melting ice in an ice well.

### (2) Description of Related Art Including Information Disclosed Under 37 CFR 1.97 and 1.98

The prior art discloses myriad heating devices which include heating elements housed in a mat. Often, these devices are intended to melt snow and ice which lies on the mat. However, the prior art fails to describe a heating device which includes heating elements embedded in a body made of a flexible, fluid impermeable material and having holes extending through the body to drain water. Such a device would be advantageous in melting ice kept in a sink or ice well. Bars, restaurants, and similar facilities are required to refresh the ice kept in ice wells for sanitary purposes. It may also be desirable to melt and drain ice for other reasons such as to clean an ice well of broken glass which has fallen into the well. A new device as described would be beneficial for these purposes.

### BRIEF SUMMARY OF THE INVENTION

An embodiment of the disclosure meets the needs presented above by generally comprising a body constructed of a fluid impermeable material which is flexible such that the body is configured to conform to an exterior of a pile of ice. The body defines a plurality of holes which extend through the body to facilitate draining water through the body. A resistive heating wire is embedded in the body.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a heating device according to an embodiment of the disclosure.

FIG. 2 is a detail view of a power module of an embodiment of the disclosure.

FIG. 3 is a front view of an embodiment of the disclosure.

FIG. 4 is a cross section view of an embodiment of the disclosure taken from Arrows 4-4 in FIG. 3.

FIG. 5 is a detail view of a power module an embodiment of the disclosure.

FIG. 6 is an exploded in-use view of an embodiment of the disclosure.

FIG. 7 is an in-use view of an embodiment of the disclosure.

FIG. 8 is a perspective view of an embodiment of the disclosure.

### DETAILED DESCRIPTION OF THE INVENTION

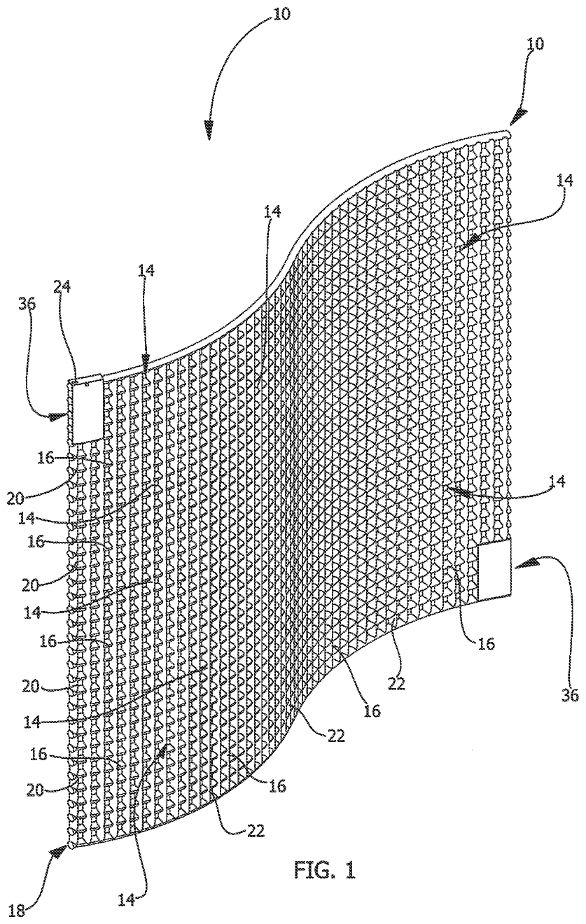

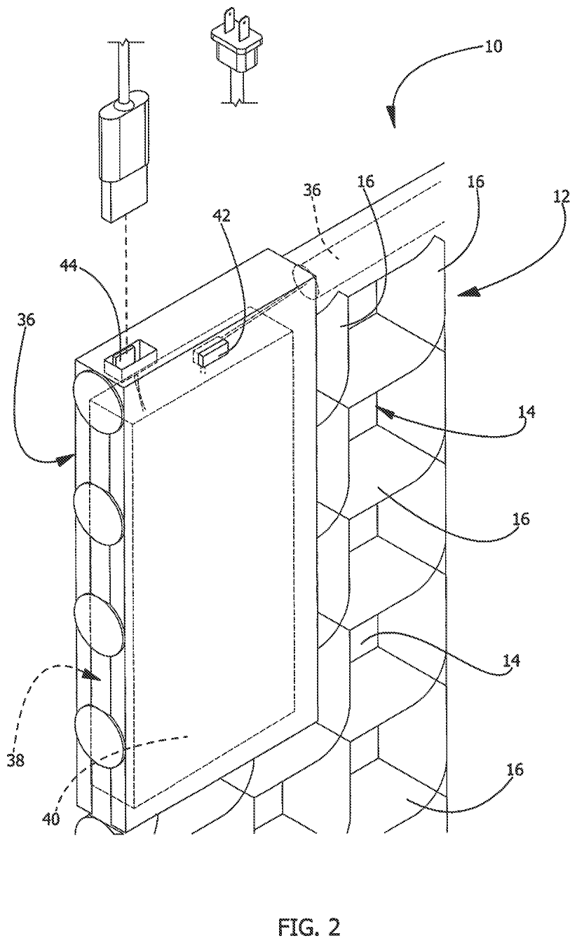

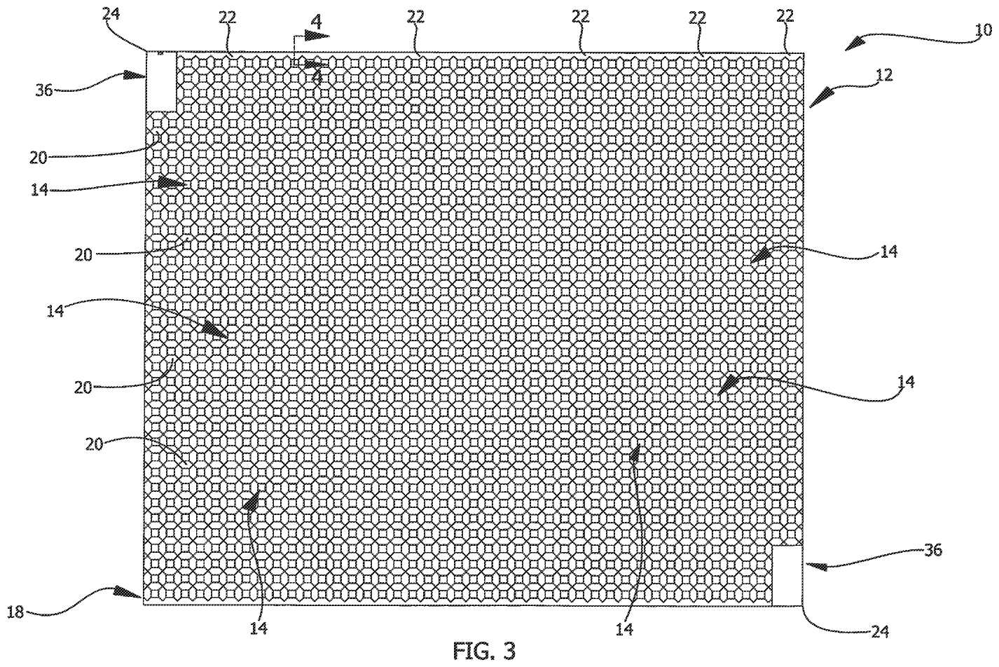

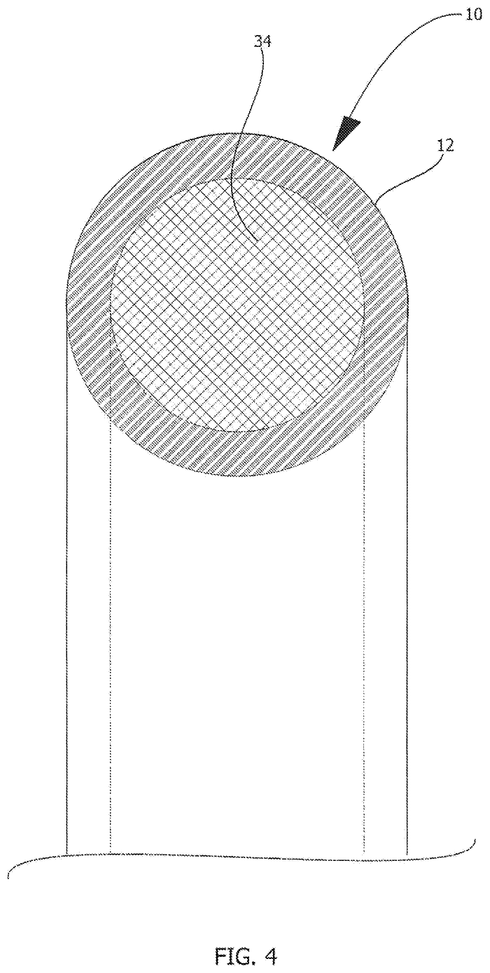

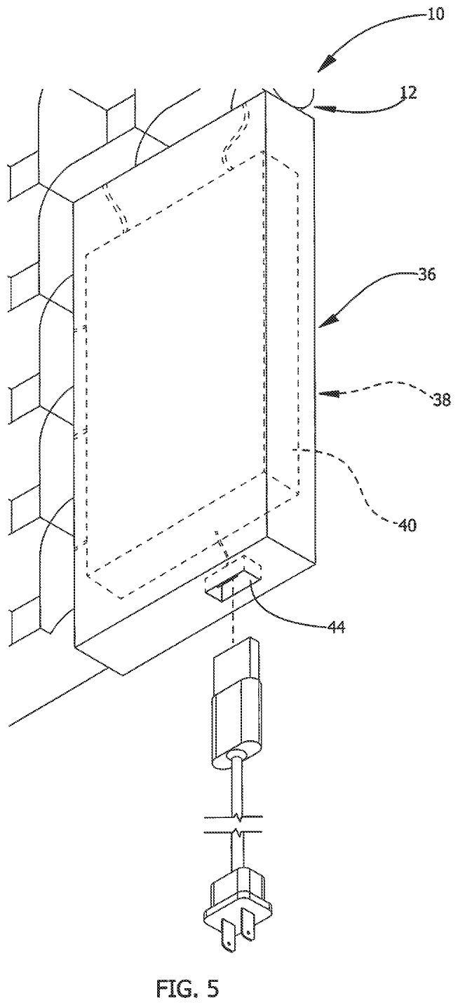

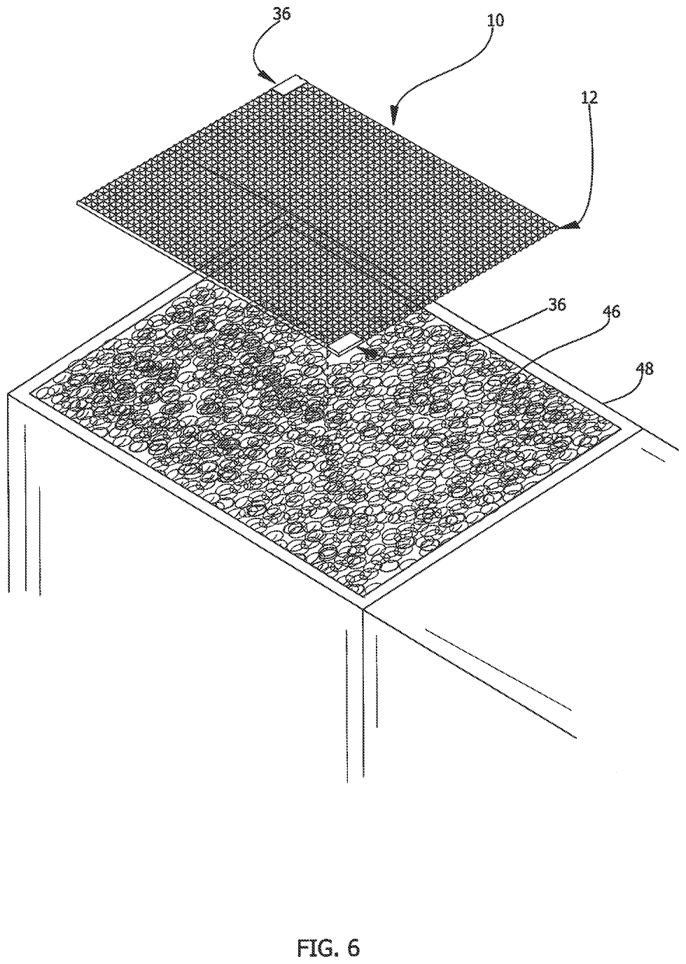

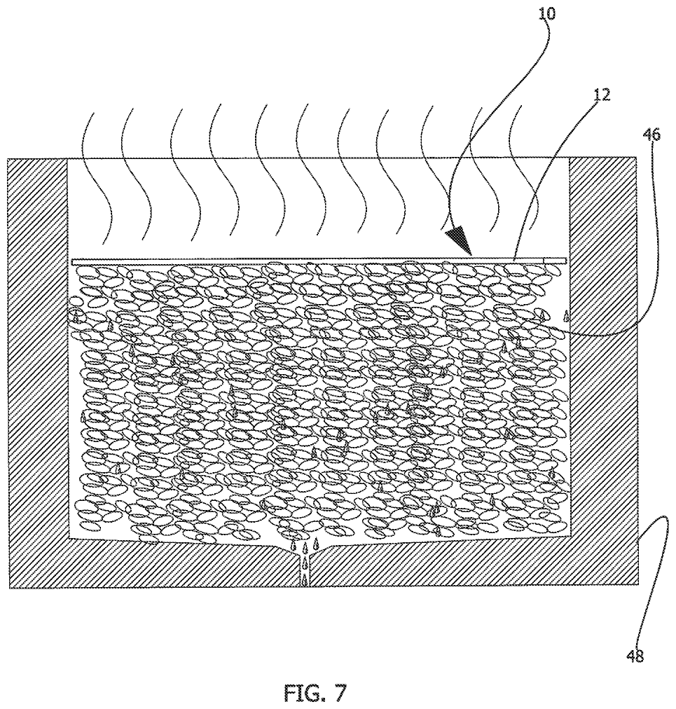

With reference now to the drawings, and in particular to FIGS. 1 through 8 thereof, a new heating device embodying the principles and concepts of an embodiment of the disclosure and generally designated by the reference numeral 10 will be described.

As best illustrated in FIGS. 1 through 8, the heating device 10 generally comprises a body 12 comprises a fluid impermeable material which is flexible such that the body 12 is configured to conform to an exterior of a pile of ice 46. The fluid impermeable material may be, for example, rubber, silicone, another polymer, or the like. The body 12 defines a plurality of holes 14 which extend through the body 12 wherein the plurality of holes 14 is configured to facilitate draining water through the body 12. The body 12 is formed from a plurality of elongated members 16. The elongated members 16 are interconnected and are arranged to define the plurality of holes 14.

A resistive heating wire 34 is embedded in the body 12. A power module 36 is coupled to the body 12 and comprises a power source 38, a power switch 42, and a charging port 44. The power source 38 is selectively electrically couplable to the resistive heating wire 34 and comprises a battery 40. The power source 38 is embedded in the body 12. The power switch 42 is electrically coupled to the resistive heating wire 34 and the power source 38. The power switch 42 is operable to alternately electrically couple and decouple the resistive heating wire 34 and the power source 38. The charging port 44 is electrically coupled to the power source 38 and is positioned on an exterior of the body 12. The charging port 44 may be waterproof or water resistant. In some embodiments, the resistive heating wire 34 may be powered by an external power supply, or the battery 40 may be interchangeable with a replacement battery 40.

In a first embodiment of the heating device 10 as depicted in FIGS. 1 through 7, the body 12 has a rectangular shape 18. The plurality of elongated members 16 includes a set of first elongated members 20 and a set of second elongated members 22. Each first elongated member 20 of the set of first elongated members 20 extends in a first direction, and each second elongated member 22 of the set of second elongated members 22 extends in a second direction perpendicular to the first direction. Each first elongated member 20 of the set of first elongated members 20 is coupled to each second elongated member 22 of the set of second elongated members 22. The first elongated members 20 are evenly spaced from each other and the second elongated members 22 are evenly spaced from each other. The set of first elongated members 20 and the set of second elongated members 22 are integrally formed with each other. The power module 36 is one of a pair of power modules 36, each of which is positioned in opposite corners 24 of the body 12.

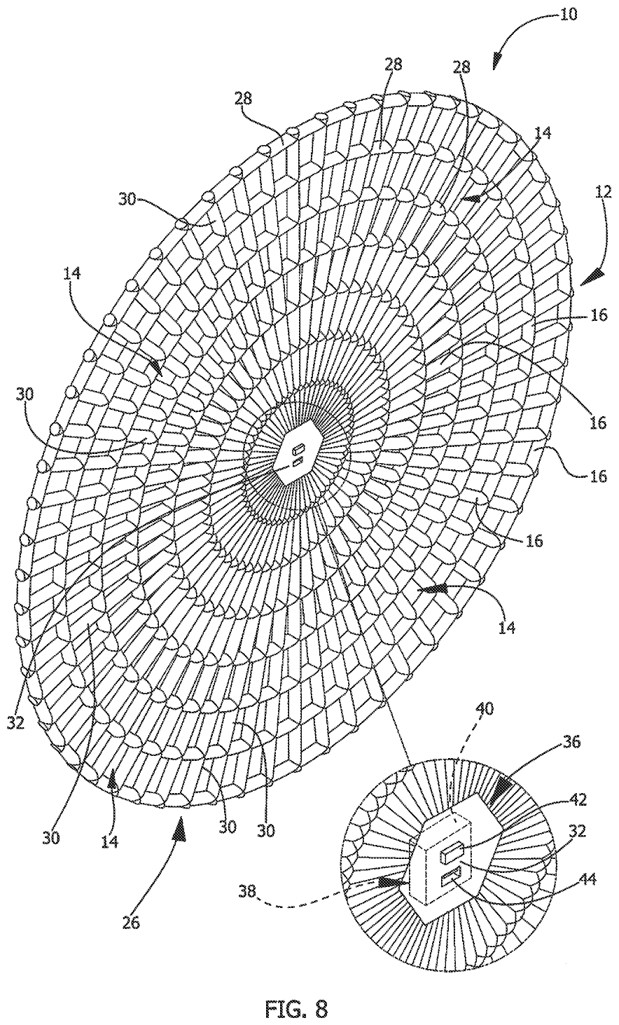

In a second embodiment of the heating device 10 as depicted in FIG. 8, the body 12 has a circular shape 26. The plurality of elongated members 16 includes a set of circular elongated members 28 and a set of radial elongated members 30. The circular elongated members 28 are positioned concentrically with respect to each other, and the circular elongated members 28 are evenly spaced from each other. Each radial elongated member 30 of the set of radial elongated members 30 extends radially out from a center 32 of the body 12 and is coupled to each circular elongated member 28 of the set of circular elongated members 28. The set of radial elongated members 30 and the set of circular elongated members 28 are integrally formed with each other. The power module 36 is positioned at the center 32 of the body 12.

In use, the heating device 10 is placed onto the pile of ice 46, which may be positioned in an ice well 48, a sink, or other container. The switch is operated to activate the resistive heating wire 34, which transfers heat through the body 12 to the ice 46 and melts the ice 46.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A heating device for melting ice in an ice well, the device comprising:
a body comprising a fluid impermeable material, the fluid impermeable material being flexible such that the body is configured to conform to an exterior of a pile of the ice, the body defining a plurality of holes which extend through the body wherein the plurality of holes is configured to facilitate draining water through the body; and
a resistive heating wire being embedded in the body.

2. The device of claim 1, wherein the body is formed from a plurality of elongated members, the plurality of elongated members being interconnected.

3. The device of claim 1, further comprising a power module which is coupled to said body, the power module comprising:
a power source being selectively electrically couplable to the resistive heating wire, the power source comprising a battery, the power source being embedded in the body; and
a power switch being electrically coupled to the resistive heating wire and the power source, the power switch being operable to alternately electrically couple and decouple the resistive heating wire and the power source.

4. The device of claim 3, wherein the power module further comprises a charging port being electrically coupled to the power source, the charging port being positioned on an exterior of the body.

5. The device of claim 1, wherein the body has a rectangular shape, the plurality of elongated members including a set of first elongated members and a set of second elongated members, each first elongated member of the set of first elongated members extending in a first direction, each second elongated member of the set of second elongated members extending in a second direction perpendicular to the first direction, each first elongated member of the set of first elongated members being coupled to each second elongated member of the set of second elongated members.

6. The device of claim 5, wherein the elongated members of the set of first elongated members are evenly spaced from each other, the set of second elongated members being evenly spaced from each other.

7. The device of claim 5, wherein the set of first elongated members and the set of second elongated members are integrally formed with each other.

8. The device of claim 1, wherein the body has a circular shape, the plurality of elongated members including a set of circular elongated members and a set of radial elongated members, the set of circular elongated members being positioned concentrically with respect to each other, the set of circular elongated members being evenly spaced from each other, each radial elongated member of the set of radial elongated members extending radially out from a center of the body, each radial elongated member of the set of radial elongated members being coupled to each circular elongated member of the set of circular elongated members.

9. The device of claim 8, wherein the set of radial elongated members and the set of circular elongated members are integrally formed with each other.

10. A heating device for melting ice in an ice well, the device comprising:
a body comprising a fluid impermeable material, the fluid impermeable material being flexible such that the body is configured to conform to an exterior of a pile of the ice, the body defining a plurality of holes which extend through the body wherein the plurality of holes is configured to facilitate draining water through the body, the body being formed from a plurality of elongated members, the plurality of elongated members being interconnected;
a resistive heating wire being embedded in the body; and
a power module being coupled to said body and comprising:
a power source being selectively electrically couplable to the resistive heating wire, the power source comprising a battery, the power source being embedded in the body;
a power switch being electrically coupled to the resistive heating wire and the power source, the power switch being operable to alternately electrically couple and decouple the resistive heating wire and the power source; and
a charging port being electrically coupled to the power source, the charging port being positioned on an exterior of the body.

11. The device of claim 10, wherein:
the body has a rectangular shape, the plurality of elongated members including a set of first elongated members and a set of second elongated members, each first elongated member of the set of first elongated members extending in a first direction, each second elongated member of the set of second elongated members extending in a second direction perpendicular to the first direction, each first elongated member of the set of first elongated members being coupled to each second elongated member of the set of second elongated members, the set of first elongated members being evenly spaced from each other, the set of second elongated members being evenly spaced from each other, the set of first elongated members and the set of second elongated members being integrally formed with each other; and
the power module being one of a pair of power modules, the pair of power modules being positioned in opposite corners of the body.

12. The device of claim 10, wherein:
the body has a circular shape, the plurality of elongated members including a set of circular elongated members and a set of radial elongated members, the set of circular elongated members being positioned concentrically with respect to each other, the set of circular elongated members being evenly spaced from each other, each radial elongated member of the set of radial elongated members extending radially out from a center of the body, each radial elongated member of the set of radial elongated members being coupled to each circular elongated member of the set of circular elongated members, the set of radial elongated members and the set of circular elongated members being integrally formed with each other; and
the power module being positioned at the center of the body.
